(19) United States
(12) Patent Application Publication
(10) Pub. No.: US 2020/0191673 A1
(43) Pub. Date: Jun. 18, 2020

(54) Capacitive Pressure Transducer

(71) Applicant: Guanghua Wu, McKinney, TX (US)

(72) Inventor: Guanghua Wu, McKinney, TX (US)

(21) Appl. No.: 16/501,466

(22) Filed: Oct. 22, 2018

(51) Int. Cl. G01L 9/00; G01L 19/00; G01L 19/14

(52) U.S. Cl. CPC G01L 9/0075; G01L 19/14; G01L 19/0061

(57) ABSTRACT

A variable capacitance type pressure transducer is constructed by electrically conductive diaphragm and electrode disposed on the surface of a dielectric disk. The gap between electrode and diaphragm is formed and solely decided by a spacer made of Super Invar or Invar, which has extra low thermal expansion coefficient. The gap between the electrode and the diaphragm is formed easily and almost no change when temperature of the transducer changes. The dielectric disk is centered with diaphragm radically by a mating between a pin made on the top lid of the pressure transducer and a center hole on the dielectric disk.

### FIELD OF THE INVENTION

The present invention is related to capacitive pressure transducers and more specifically to manometers or capacitive diaphragm gauges (CDG).

### BACKGROUND OF THE INVENTION

Capacitive pressure transducers use one or more variable capacitor(s) to measure pressure. To be accurate and have a high resolution, the gap between two electrodes of the capacitor(s) needs to be small and stable (do not change with temperature and time). As used herein, the gap g is defined as the gap between diaphragm and electrode after assembling of the pressure transducer before it is evacuated for reference pressure, and because the electrode is very thin, the electrode surface and ceramic disk surface are not distinguished. During operation, due to the temperature change and thermal expansion coefficient differences among diaphragm, body and ceramic disk, there will be relative movement among the components, and the gap g changes as a result. To obtain a repeatable initial capacitor gap g inexpensively is also desirable. If the accuracy and repeatability of the gap g rely on that of many components, or on adjustment of spacers, the cost in machining and assembling will be high.

During operation, the diaphragm is deflected and not flat any more. The maximum deflection will be in the center of the diaphragm, and the capacitance of the variable capacitor will also depend on the relative location between the electrode and diaphragm. Other than capacitor gap g, a stable concentricity between the electrode on ceramic disk and diaphragm is also very important. More importantly, the relative position between the electrode and the diaphragm should not change in the life time of the pressure transducer. The expansion and contraction of the ceramic disk should not be impeded severely enough to alter the position of the disk or deform the electrode.

### SUMMARY OF THE INVENTION

To increase the accuracy and stability of pressure transducer, especially in the area obtaining and maintaining a stable capacitor gap g easily and inexpensively, this invention uses a spacer made of low thermal expansion coefficient material, Super Invar or Invar or equivalent material to define the gap g. To keep concentricity of electrode and diaphragm, this invention uses a center pin of the transducer body and center hole on the electrode disk to support the electrode disk.

### BRIEF DESCRIPTION OF THE DRAWINGS

FIG. 1 is a section view of this invention.

FIGS. 2A, 2B and 2C are top view, section view and bottom view of ceramic electrode disk of this invention, respectively.

FIGS. 3A, 3B and 3C are isometric view, top view and section view of top lid assembly of this invention, respectively.

FIGS. 4A and 4B are section view and isometric view of body assembly of this invention, respectively.

FIG. 5 shows the waved spring of this invention.

FIG. 6 is a drawing of ceramic disk with normal and friction forces on it.

FIG. 7 is an isometric view of the pressure transducer of this invention showing the cover spot-welding.

### DETAILED DESCRIPTION OF THE INVENTION

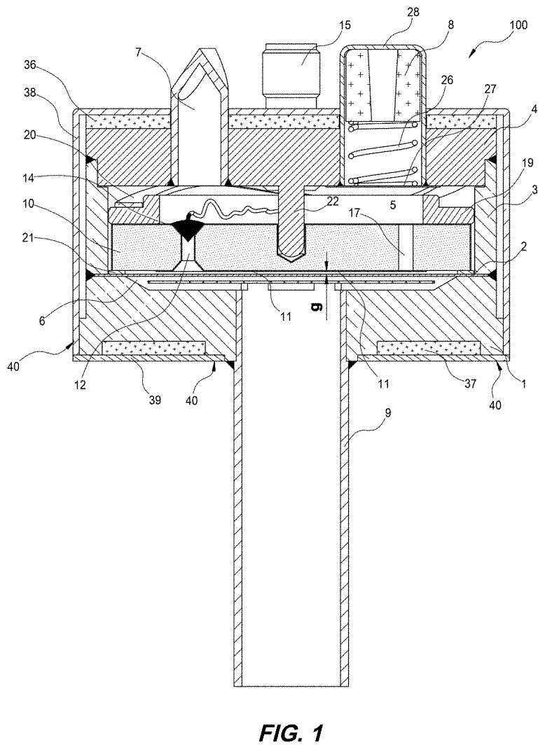

FIG. 1 is a section view of this invention. The housing of pressure transducer 100 is formed by bottom flange 1, diaphragm 2, middle cylinder 3 and top lid 4, welded together air-tightly. All of these parts are made of stainless steel, preferably 316L VIM/VAR or Inconel.

The housing is divided by diaphragm 2 into two chambers, 5 and 6. By using pinch-off tube 7 to evacuate the chamber 5 first and then sealing the tube 7, activating getter 8 to absorb residual gases, the absolute pressure inside chamber 5 can be kept close to zero. This provides a reference pressure for the pressure transducer 100. Chamber 6 is connected to the pressure to be measured through tube 9, preferably made of stainless steel, welded to the bottom flange 1.

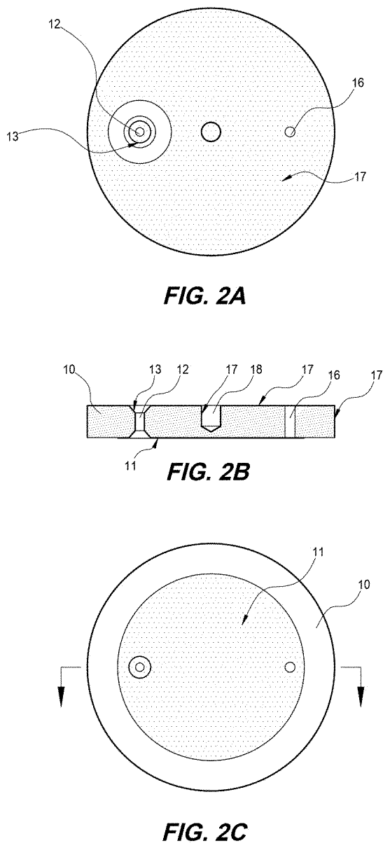

Disk 10 made of ceramic (AL₂O₃) has an electrically conductive gold or nickel electrode 11 disposed on its bottom surface (also shown in FIG. 2C). There is a through hole 12 on the disk 10. The internal surface of the hole 12 is plated with electrically conductive layer 13 (FIG. 2B). Electrical signal from electrode 11 will be conducted to the outside of the pressure transducer 100 through this hole by soldering (14 shown in FIG. 1) on the top end of the hole, wire and connector 15. Electrode 11 and electrically conductive diaphragm 2 form a variable capacitor. As the diaphragm 2 is flexible and will deflect under the pressure difference between chambers 5 and 6, the gap g between electrode 11 and diaphragm 2 is also changing consequently, so is the values of the capacitance, which can be detected by outside circuit (not shown) as an indication of differential pressure across diaphragm 2. Port 16 on disk 10 (FIG. 2B) will make sure the pressure in the gap g is the same as that in the top part of the chamber 5.

To eliminate parasitic or stray capacitance, as illustrated in FIG. 2B, the peripherical surface and part of top surface of ceramic disk 10 are plated with electrically conductive layer 17. The surface of center hole 18 is plated as well. This conductive layer 17 will be grounded through spring guidance ring 19 and wave spring 20 (FIG. 1), both of them are made of stainless steel. As shown in FIG. 2A, there is a circular gap between the top part of this layer 17 and the plating 13 on through hole 12.

As shown in FIG. 1, a ring-shaped spacer 21 made of Super Invar or Invar or equivalent low thermal expansion coefficient material is inserted between ceramic disk 10 and diaphragm 2. Super Invar and Invar, both of them iron-nickel metals, have a thermal expansion coefficient 0.5˜0.63 μm/m·° C. If the spacer thickness (also the gap g) is assumed to be 0.003″, the percentage change will only be 0.000063%/° C. This makes the thermal expansion not an issue any more. The measures used to compensate the temperature influence, such as double electrodes, etc. will not be needed, save the cost in hardware and software. The spacer 21 can be made by stamping or etching from Super Invar or Invar sheet. As the initial gap g in the embodiment is solely depended on the thickness of the spacer 21, and the thickness of the sheet made the spacer is easy to control, this also provides a repeatable and low-cost way to obtain the initial capacitor gap g. As the thermal expansion coefficients of diaphragm 2 and middle cylinder 3 are larger than that of the spacer 21, the fit between middle cylinder 3 and spacer 21 can be a slide fit, no excessive clearance between the internal diameter of middle cylinder 3 and outside diameter of spacer 21 is needed.

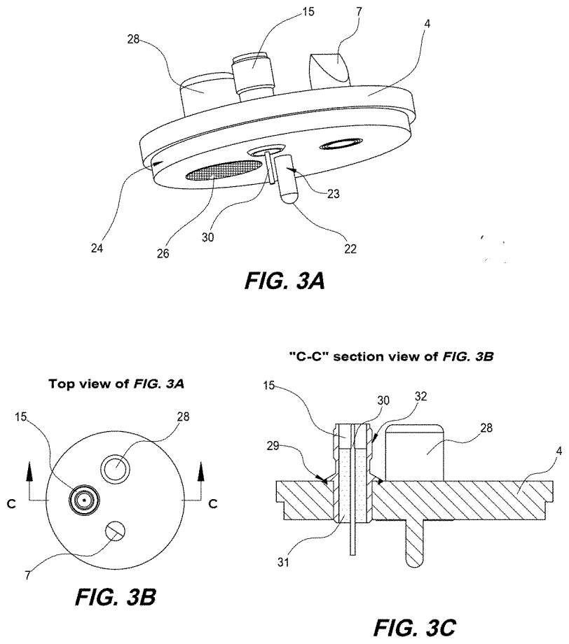

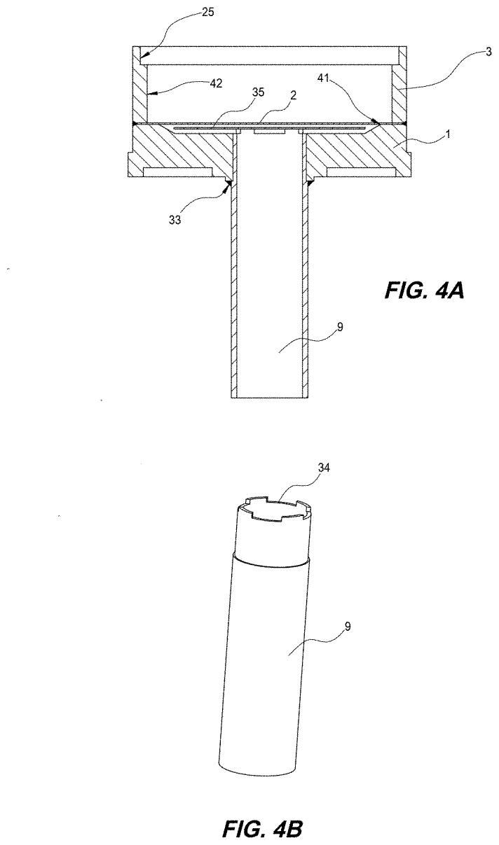

In this invention, the centering of disk 10 is realized by the mating between the center hole 18 (FIG. 2B) on the disk and protruding pin 22 (FIG. 1 and FIG. 3A) of the top lid 4. The measures to keep them concentric are: in the machining of top lid 4, the peripherical surface 23 of center pin 22 is kept concentric with the peripherical surface 24 (FIG. 3A); the fit between top lid assembly (FIG. 3A) and body assembly (FIG. 4A) (between surface 24 of top lid 4 and cylindrical surface 25 of middle cylinder) is a slight press fit to assure their concentricity and facilitate the assembling; during welding of bottom flange 1, diaphragm 2 and middle cylinder 3, fixture will be used to keep them concentric. As the top lid's thermal expansion coefficient is larger than that of ceramic disk, a large enough clearance should be provided between center pin 22 of top lid 4 (FIG. 1 and FIG. 2A) and center hole 18 of ceramic disk 10 (FIG. 2B) to avoid interference between them when temperature rises. Calculation shows that that preferred close sliding fit will not cause interference during temperature up and down. Ceramic disk 10 will expand and contract with the temperature radially, but as its center is fixed by the pin 22, its relative position to diaphragm will be kept unchanged.

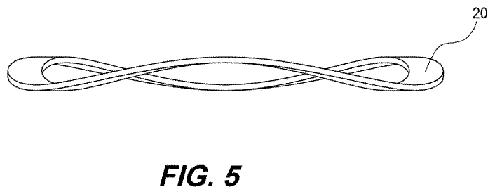

Spring guidance ring 19 and wave spring 20 are disposed above the ceramic disk 10 (FIG. 1) to counterbalance the pressure force implied by the differential pressure across the diaphragm 2 through spacer 21. As the expected maximum differential pressure is around 1,000 torr for monometer applications, the maximum pressure force is around 40 pound (18 kg), the working load of the wave spring can be chosen to be somewhere above 100 pounds to have some safety room (in this invention, the working load of the waved spring is chosen as 40 pounds). One reason to use guidance ring 19 is that the waved spring 20 (FIG. 5) has limited waves (three in this invention), if the waved spring contacted ceramic disk directly, it would cause stress concentration on the contact points. Also, the plated layer 17 would be damaged at the contact points by the constant rubbing due to the temperature change. The fit between guidance ring 19 and middle cylinder 3 is also close sliding fit to keep them concentric. As the thermal expansion coefficients of them are the same, there is no possibility of interference between them during temperature up and down. The guidance ring 19 is also providing a guidance for waved spring 20 to ensure the waved spring will not have the possibility to alter the position of the disk 10 by temperature change or impacts of shipping and handling.

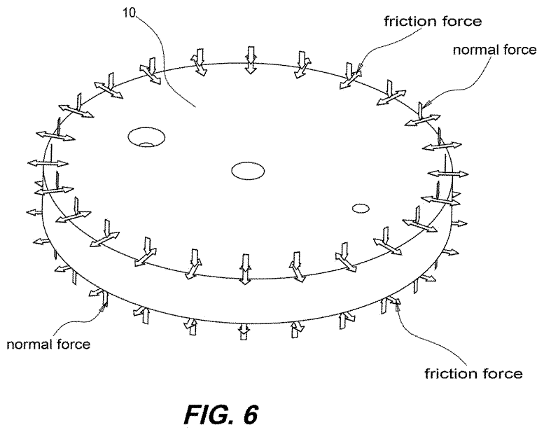

Referring to FIG. 1, when temperature rises, the ceramic disk 10 moves outwards radially related to the Super Invar spacer 21 under it, and the guidance ring 19 moves outwards radially related to ceramic disk 10 under it (guidance ring 19 has the largest thermal expansion coefficient and Super Invar spacer 21 has the smallest thermal expansion coefficient). Both the friction forces are: F_{f}=μF_{N}, where μ is friction coefficient and F_{N} is the normal force, here is 140 pounds. If we assume the friction coefficients are the same for both top side and bottom side of ceramic disk 10 as 0.4, the friction force will be 56 pounds. FIG. 6 shows the disk 10 under normal force and friction force. Finite element calculation shows that the maximum deformation is 4.6×10⁻⁶ inch, and the maximum Von Mises stress is 6.9 MPa, both of them are not going to produce significant influence on electrode's deformation.

As shown in FIG. 1 and FIG. 2A, underneath the getter 8, there is spring 26 rested on getter screen 27, which is spot-welded to top lid 4 to keep fluid communication between the internal volume of getter case 28 and main chamber 5. The function of spring 26 is to push getter 8 to the top of the getter case 28. After the chamber 5 is evacuated and the tube 7 is sealed, an induction heating coil can be put around the getter case 28, heat the getter to actuated it.

As shown in FIG. 3C, hermetic connector 15 is welded to the top lid 4 from the top (29). The connector 15 has a center pin 30 and glass seal 31. It can be connected to the circuit board by thread 32, or other means. Connector 15 can be bought out of shelf, or customer made. The low end of the pin 30 will be soldered to a wire, which is connected to ceramic disk 10 by soldering 14 (FIG. 1). As the top lid assembly will be welded to the body assembly permanently, connect the electrode to the outside by wire and soldering may be a more reliable and less expensive way to do than using a contact spring.

As shown in FIG. 1 and FIG. 4A, inlet tube 9 is air-tightly fillet-welded to bottom flange 1 (33). See FIG. 4B, the top end of inlet tube 9 has four slots 34. When inlet shield 35 is spot-welded to it, there will be four passages for the fluid to flow through. Shield 35 is circular plain sheet metal part, preferably made of 3xx series stainless steel and is used to protect the diaphragm 2 from contamination and impacts of sudden pressure surges.

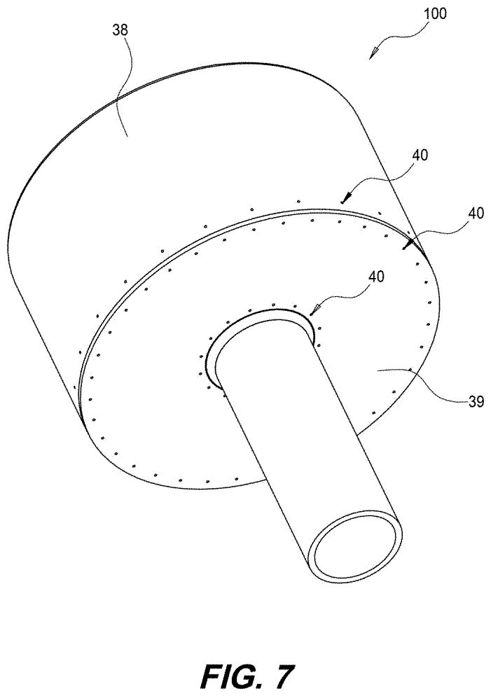

Referring to FIG. 1, items 36 and 37 are isolation layers, can be made of foams. Top cover 38 and bottom cover 39, preferably made of stainless-steel sheet, are both spot-welded to the bottom flange 1 (40 in FIG. 1 and FIG. 7).

Referring to FIG. 4A of the body assembly, the diameter 41 of the edge on bottom flange 1 is close to the internal diameter of spacer 21 (FIG. 1) to provide a support for the spacer. The cylindrical surfaces 25 and 42 of middle cylinder 3 should be made concentric and should be concentric with diaphragm 2 after welding.

What is claimed is:

1. A pressure transducer comprising:
a variable capacitor comprising a first electrode formed by an electrically conductive diaphragm that moves in response to a differential pressure applied across said diaphragm and a second electrode comprising electrically conductive material disposed on a dielectric disk comprising dielectric material; and
a spacer comprising low thermal expansion coefficient material inserted between said diaphragm and said disk.

2. The pressure transducer of claim 1 wherein said differential pressure is formed between two chambers on both sides of said diaphragm, one chamber is set to a reference pressure and another chamber is connected to the pressure to be measured.

3. The pressure transducer of claim 2 wherein said chambers comprise electrically conductive housing bodies, including top lid, side cylinder, bottom flange, and said diaphragm welded together.

4. The pressure transducer of claim 1 wherein said disk with said second electrode on its surface opposite to said diaphragm rests on said spacer, said second electrode being concentric and parallel to said diaphragm, a gap being formed between said electrode and said diaphragm.

5. The pressure transducer of claim 1 wherein said low thermal expansion coefficient material comprises to Super Invar, Invar or equivalent alloys, with a thermal expansion coefficient significantly below that of regular metals, i.e., <3 μm/m·° C.

6. The pressure transducer of claim 4 wherein the value of said gap between said diaphragm and said second electrode is equal to the thickness of said spacer.

7. The pressure transducer of claim 1 wherein said disk including the said second electrode is centered radially with said diaphragm by the mating between a pin on said top lid, and a center hole on said disk, and said pin moves freely axially inside said center hole.
